(19) United States
(12) Patent Application Publication
(10) Pub. No.: US 2025/0086044 A1
(43) Pub. Date: Mar. 13, 2025

(54) SYSTEMS AND METHODS FOR MULTI-SYSTEM FAULT DETERMINATION

(71) Applicant: SAP SE, Walldorf (DE)

(72) Inventor: Manish Gupta, Bruchsal (DE)

(21) Appl. No.: 18/464,133

(22) Filed: Sep. 8, 2023

(51) Int. Cl. G06F 11/07

(52) U.S. Cl. CPC G06F 11/0787

(57) ABSTRACT

Embodiments of the present disclosure include techniques for determining faults across multiple software applications. In one embodiment, a configuration table is loaded with information specifying relationships between software applications. Fault events from the software applications are received and stored in a fault log database. A query is received pertaining to a fault in one of the applications, and the information in the configuration table is used to determine details about faults in other software applications related to the fault specified in the query. The other software systems are accessed to retrieve fault information, and a fault relationship table is populated providing more insight into relationships between faults across the applications.

### BACKGROUND

The present disclosure relates generally to software system, and in particular, to systems and methods for multi-system fault determination.

Enterprise IT landscapes have been evolving in over the years with mix of new cloud delivered services and on-premise software systems. Distributed multi-system architectures and microservices are becoming a popular choice for enterprises. With above approach, business users often need to work on several systems to complete their tasks, such as marketing, quotation management, sales order management, invoicing, and billing to name just a few.

Business users working on a software system generally do not get to see what runs behind the user interface. A software application might be connected to several other applications on different servers and many integrations may run on every user interaction, for example. Any runtime integration error could result in a break in the user experience and force user to close the process prematurely. This consumes time, results in productivity loss, and delay to complete the business process.

Any incomplete process in other connected systems might go unnoticed from a business user and would be difficult to fix. Information technology (IT) technical support teams may need to analyze the transaction in connected systems, and this could be challenging given different integration technologies, APIs, and middleware used in the IT landscape.

The present disclosure addresses these and other challenges and is directed to techniques for improving fault detection in multi-system environments.

### BRIEF DESCRIPTION OF THE DRAWINGS

FIG. 1 illustrates a system for software system for multi-system fault determination according to an embodiment.

FIG. 2 illustrates a method for software system for multi-system fault determination according to an embodiment.

FIG. 3 illustrates an example architecture for multi-system fault determination according to an embodiment.

FIG. 4A illustrates an example hierarchy of interacting applications according to an embodiment.

FIG. 4B illustrates an example configuration table according to an embodiment.

FIG. 4C illustrates an example fault event used in multi-system fault determination according to an embodiment.

FIG. 4D illustrates an example process flow for multi-system fault determination according to an embodiment.

FIG. 4E illustrates an example fault log table and relation table according to an embodiment.

FIG. 4F illustrates an example graph of information describing a fault according to an embodiment.

FIG. 5 illustrates hardware of a special purpose computing system configured according to the above disclosure.

### DETAILED DESCRIPTION

Described herein are techniques for multi-system fault determination. In the following description, for purposes of explanation, numerous examples and specific details are set forth in order to provide a thorough understanding of some embodiments. Various embodiments as defined by the claims may include some or all of the features in these examples alone or in combination with other features described below and may further include modifications and equivalents of the features and concepts described herein.

Features and advantages of the present disclosure include an interface to check integration errors and improve business user's knowledge in integration topics. In various scenarios, users may experience multi-system faults such as: released a quote for a booking but no contract is created, no content management server connection available so cannot upload customer documents, cloud tenant provisioning is not done for customer and escalation is expected, forecast figures are incorrect for current quarter and compensation will be affected, due date for a cloud renewal order is passed but no renewal order is created, product “xyz” not available for quoting and user cannot sell it to customers, missing compliance checks stops deal approval, and the like. Embodiments of the present disclosure may include a dynamic fault analysis system that traces faults in connected systems and applications and derive a relationship with a given business process or business object, for example. In some embodiments, the disclosure includes an event based architectural approach which can assess faults and problems proactively and can notify the users/applications. Some embodiments may provide comprehensive visibility on connected services and how faults can propagate in a hierarchy of connected systems. Various embodiments may simplify the process of fault analysis and the impact on critical business processes by producing an output with dependencies, for example.

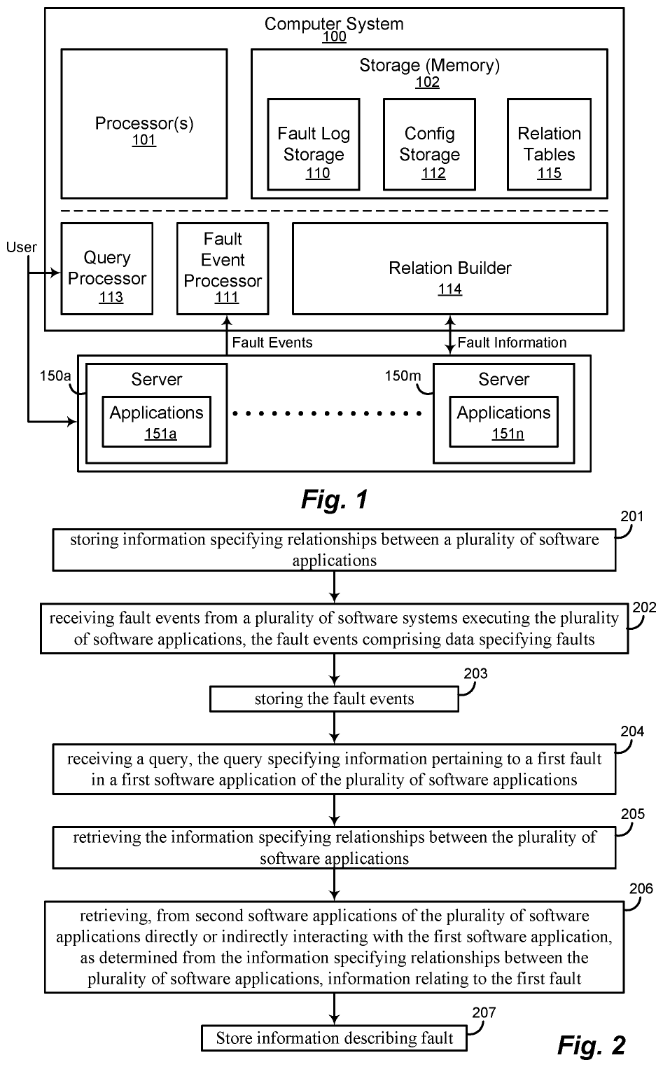

FIG. 1 illustrates a computer system 100 for performing data fixes according to an embodiment. In the example shown in FIG. 1, a computer system 100, including one or more processors 101 and storage 102 (a non-transitory computer readable medium, e.g., memory), may execute software comprising a query processor 113, event processor 111, and relation builder 114. A user may be working with a software application, which is part of a plurality of software applications (aka, applications) 151a-n that interact directly or indirectly. Applications 151a-n may run on a plurality of servers 150a-m (e.g., a customer relationship manager server may run a sales application, quote application, or the like). A user may experience a fault with the primary application they are working in, and the fault may be caused by, or related to, a plurality of faults across the interconnected applications. Accordingly, a user may desire to obtain information about the underlying causes of the fault.

Initially, embodiments of the present disclosure may store information specifying relationships between software applications 151a-n, such as in a configuration (“Config”) storage 112, for example. The information specifying relationships between the applications may indicate hierarchy of applications, including a root application the user is interacting with directly, as well as hierarchical layers of applications that interface with the root application, applications lower or higher layers in the hierarchy. Embodiments of the disclosure include a fault event processor 111 that receives fault events from applications 151a-n on servers 150a-m. The fault events comprise data specifying the faults in the various systems and may be used to access faults experienced by the user of a root application, for example. The fault events are stored in fault log storage 110 (e.g., database of fault log files).

Accordingly, a user may query the system to obtain detailed information about the error condition they are experiencing. For instance, a query is received by query processor 113. The query may specify information pertaining to a root fault in the root software application the user is interacting with (e.g., the root software application displaying “released a quote for a booking but no contract is created”). Query processor 113 may extract relevant information from the query and forward the relevant data to relation builder 114. Relation builder 114 retrieves the information specifying relationships between the plurality of software applications in config storage 112 and relevant fault event logs in fault log storage 110 to determine what software applications to retrieve data from to determine the root fault. Thus, relation builder 114 retrieves, from software applications directly or indirectly interacting with the root software application, as determined from the information specifying relationships between the plurality of software applications in config storage 112, information describing the first fault. The information describing the root fault may be obtained from multiple different software applications in a hierarchical relationship with the root application and may include a plurality of information related to fault events received and stored in fault log storage 110. The information describing the root fault may be stored in relation tables 115, for example. In some embodiments, once the information describing the root fault is compiled into the relation tables 115, it may be presented to a user (e.g., in the form of a hierarchical graph showing the hierarchy of interacting applications as well as the faults in each underlying application that relates to the root fault, for example.

FIG. 2 illustrates a method for software system for multi-system fault determination according to an embodiment. At 201, the computer performs the step of storing information specifying relationships between a plurality of software applications. At 202, the computer performs the step of receiving fault events from a plurality of software servers executing the plurality of software applications, the fault events comprising data specifying faults. At 203, the computer performs the step of storing the fault events. At 204, the computer performs the step of receiving a query. The query specifies information pertaining to a first fault in a first software application of the plurality of software applications. At 205, the computer performs the step of retrieving the information specifying relationships between the plurality of software applications. At 206, the computer performs the step of retrieving, from second software applications of the plurality of software applications directly or indirectly interacting with the first software application, as determined from the information specifying relationships between the plurality of software applications, information describing the first fault. The system may search the fault log storage 110, for example, using search relevant fields. At 207, the computer performs the step of storing the information describing the first fault in a table.

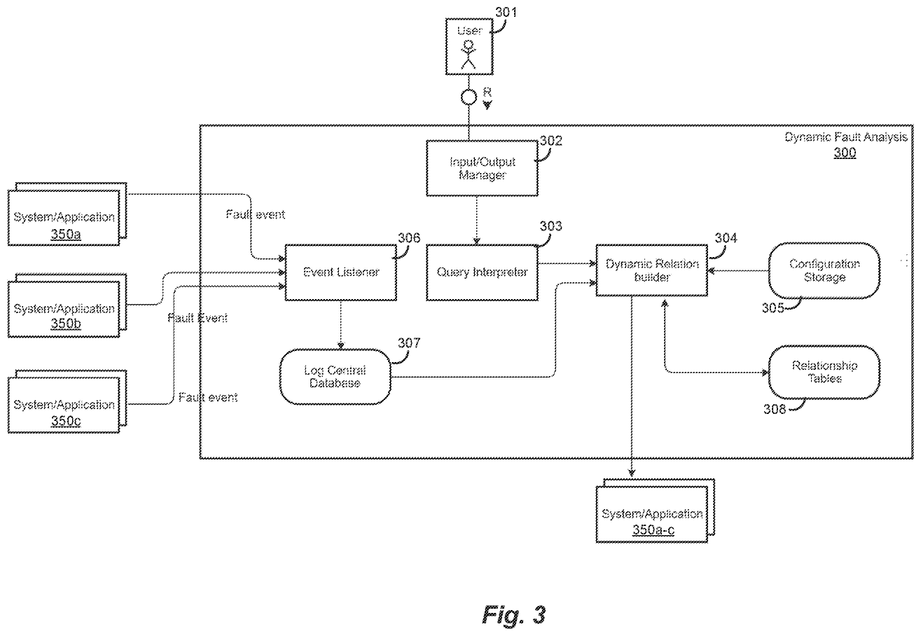

FIG. 3 illustrates an example architecture for dynamic fault analysis system 300 according to an embodiment. In this example, a user 301 may be working with a root application, such as one of the applications 350a-c, for example. When the user experiences an error or fault, dynamic fault analysis system 300 may be used to provide insight to the user (or an IT worker) about the causes of the fault. User 301 interfaces with system 300 via input/output manager 302. User 301 may input a query, which is received and processed by query processor 303. System 300 may include a dynamic relation builder 304 that retrieves information stored in configuration storage 305 and log central database 307 (aka, fault event central storage) to retrieve details of faults from other software applications 350a-c and populate relationship tables 308.

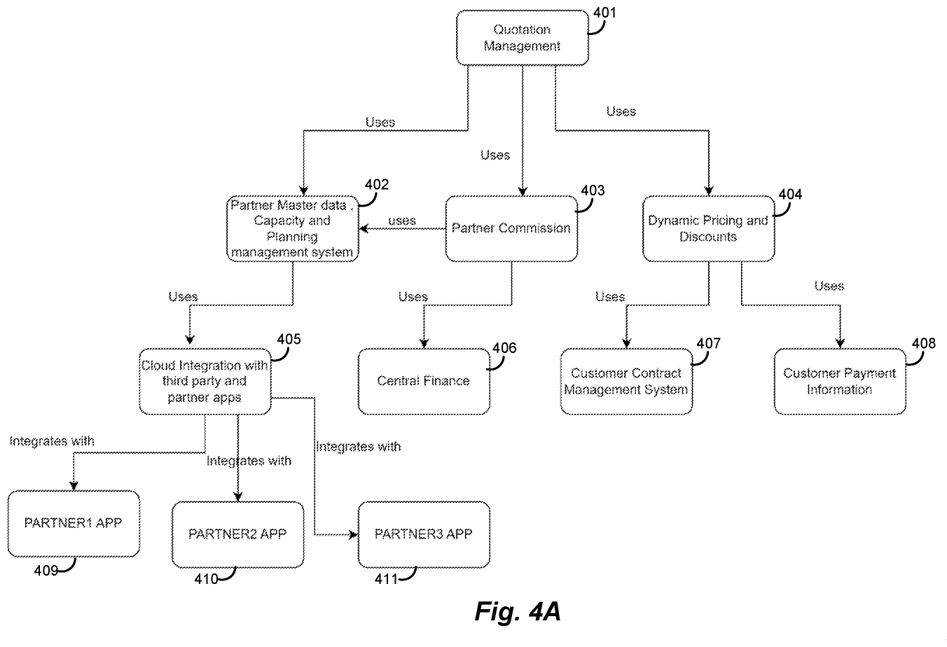

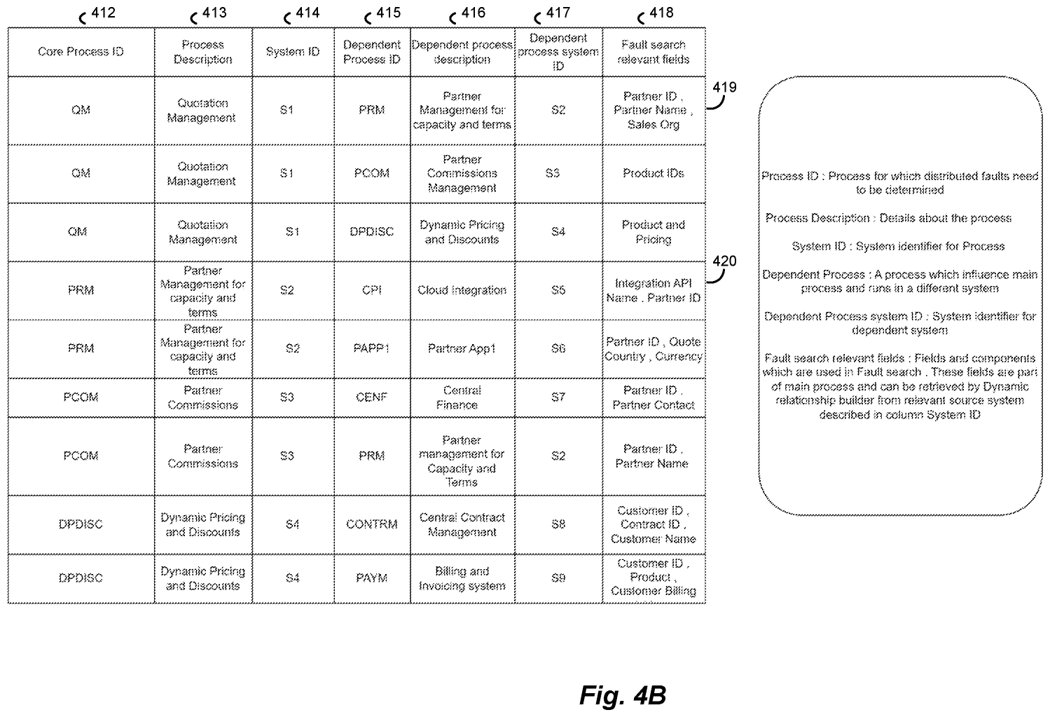

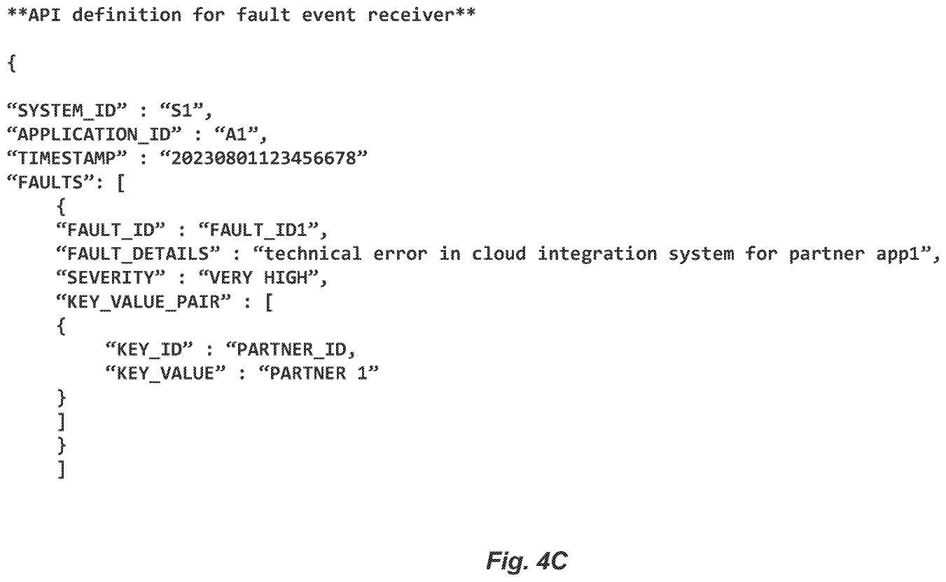

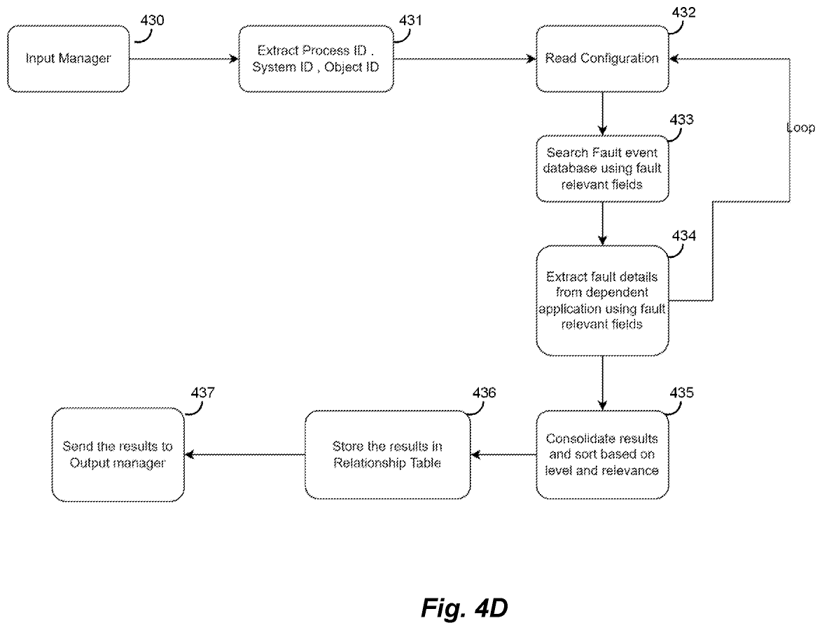

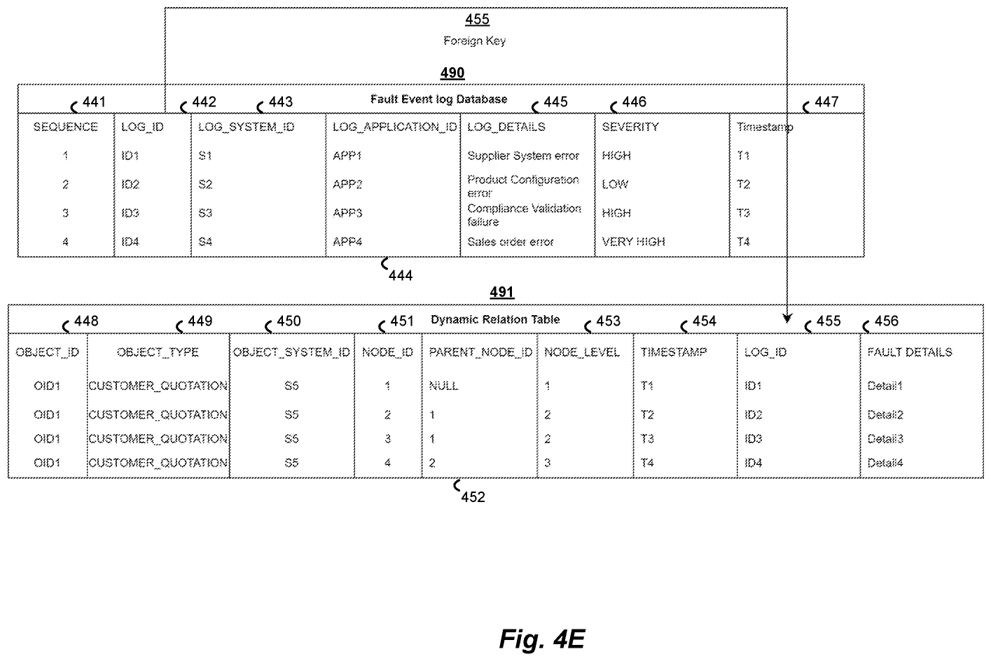

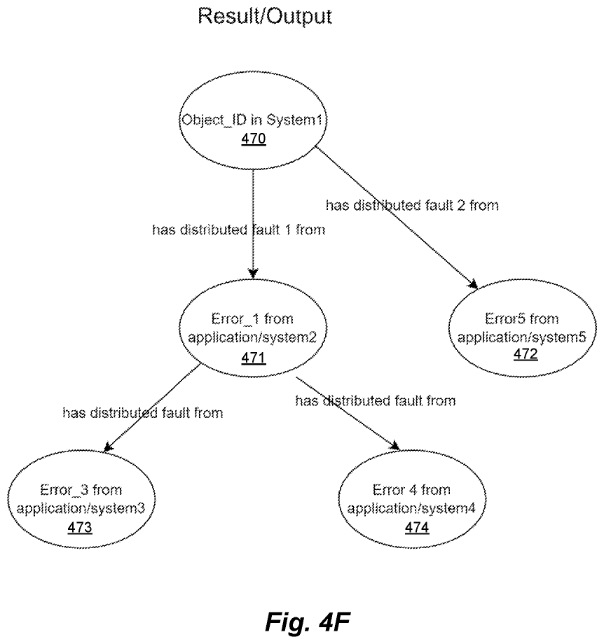

Initially, information specifying relationships between a plurality of software applications is stored in configuration storage 305. FIG. 4A illustrates an example hierarchy of interacting applications 401-411 according to an embodiment. In the example in FIG. 4A, a quotation management software application 401 uses a partner management application 402, partner commission application 403, and dynamic pricing and discounts application 404. Applications 402-404 form a first layer of a hierarchy. These applications, in turn, use other software applications 405-408 on a second level of the hierarchy, which in turn use applications 409-411 on a third layer of the hierarchy. Faults in any one or more of applications 401-411 may cause the user of the root application (here, application 401) to experience an error. The techniques described herein may be used to determine and diagnosis of interrelated faults across multiple applications forming a hierarchy, for example. Here, a root software application 401 interfaces with one or more second software applications 402-404 forming a second hierarchical layer, and the one or more second software applications 402-404 interface with a plurality of third software applications 405-408 across a use hierarchy. The information specifying relationships between the plurality of software applications may specify a position of each software application in the use hierarchy.

FIG. 4B illustrates an example configuration table according to an embodiment. Here, the information specifying relationships between a plurality of software applications comprises one or more entries 419 relating to the root application, including an identifier 412 associated with the first software application, a server identifier 414 associated with the first software application, an identifier 415 associated with a second software application dependent on the first software application, a server identifier 417 associated with the second software application, and one or more first fault search relevant fields 418. Additionally, the configuration table may include a plurality of entries (e.g., entry 420) for applications on other tiers of a hierarchy. For instance, the table may include an identifier 412 associated with a parent software application, including at least the second software application, a server identifier 414 associated with the parent software application, an identifier 415 associated with a dependent software application dependent on the parent software application, a server identifier 417 associated with the parent software application, and one or more second fault search relevant fields 418.

More specifically, in this example a quotation management system is the root application, and the configuration table stores, at 419, an ID 412, description 413, system (or server) ID 414, dependent process ID 415 (here, a partner management for capacity and terms applications, see FIG. 4A), a dependent process system (server) ID 417, and fault search relevant fields 418. In this example, the fault search relevant fields are Partner ID, Partner Name, and Sales Org. The fault search relevant fields are used to search other applications in the hierarchy (e.g., PRM application) and retrieve faults in those systems related to the fault experienced by the user in the root application. From the table in FIG. 4B, it can be seen that a parent application ID, parent application description, and parent server ID can be connected with a child application ID, child application description, child server ID, and specific fields are defined specifying criteria to search for in the child system (e.g., from the root across multiple levels of a hierarchy).

Referring again to FIG. 3, event listener 306 receives fault events from applications 350a-c, which are stored in log central database 307 and used by dynamic relation builder 304, together with data in configuration storage 305, to build relationship tables 308. FIG. 4C illustrates an example fault event used in multi-system fault determination according to an embodiment. In various embodiments, data specifying faults comprises: an identifier of the software application generating the fault event (e.g., “APPLICATION ID”: “A1”) and one or more text fields in the fault events describing the fault events. In this example, the “KEY_VALUE PAIR” comprises fields “KEY_ID”: “PARTNER ID” and “KEY_VALUE”: “PARTNER 1”, which indicate that the fault in application “A1” is related to a particular partner application specified by the KEY values above.

FIG. 4D illustrates an example process flow for multi-system fault determination according to an embodiment. In some embodiments, input manager receives a query (e.g., from the user), at 430, to determine the root application fault may specify information pertaining to a first fault comprises an identifier associated with the first software application (e.g., process ID), an object identifier associated with an object in the first software application experiencing an error condition (e.g., Object ID), and an identifier associated with a first server running the first software application (e.g., System ID). In this example, the process ID, Object ID, and System ID are extracted from the query at 431. The configuration table 305 in FIG. 3 is read at 432. The parent-child hierarchy information and fault search relevant fields 418 in FIG. 4B are used to retrieve information about the faults obtain information to access the lower applications in the hierarchy (e.g., APIs to read object, extract data from object, etc.). For instance, fault event database 307 is read using fault relevant fields at 433 (e.g., querying faults in database 307 using fault relevant fields to return matches). Fault details, processes, and timeframes (e.g., as shown in FIG. 4C) may be returned by a query of the fault log database. At 434, fault details are extracted from dependent applications using fault relevant fields. The system may repeat steps 423-434 in a loop across the applications in the hierarchy to obtain fault information from all related applications, for example. The system may iteratively connect to software applications below the root and retrieve fault events pertaining to each software applications.in the hierarchy. At 435, results are consolidated and sorted based on relevance.

FIG. 4E illustrates an example fault event log database 490 and relation table 491 according to an embodiment. As illustrated in FIG. 4E, fault event data specifying faults is stored in fault log table 490. Fault event data in this example includes a sequence number 441 (e.g., for sorting), a fault log identifier (ID) 442, a log system ID 443 specifying the server (or system) the fault came from, an application ID 444 specifying the application that generated the fault, details describing the fault 445, a severity 446, and a time stamp 447. The information in table 490 is extracted from fault events, such as the example fault event shown in FIG. 4C. Similarly, the information describing the faults gathered from across the hierarchy is shown in table 491. Each row of table 491 comprises an object ID 448, an object type 449, a server ID (object_system_id) 450, a node ID 451, a parent node ID 452, a node level 453, a timestamp 454, a fault log ID 455, and fault details 456. The fault log ID 455 is used as a foreign key 455 to the fault log ID 442 in the fault event log table 490 to link tables 490 and 491.

FIG. 4F illustrates an example graph of information describing a fault according to an embodiment. In some embodiments, the present disclosure further generating, based on the information in the relation table, a hierarchical model of interrelated fault events across the software application hierarchy, and presenting the hierarchical model to a user. In this example, the data in table 491 is represented as a hierarchical model. The model includes an object 470 in system 1, the root system coupled to objects 471 and 472 in second tier applications, which in turn are coupled to objects 473 and 474 in third tier applications. The model shows errors for each object and hierarchical relationships between them. The model provides a clear picture of the underlying causes of the error in the root application, which may be addressed manually or via an automated IT system.

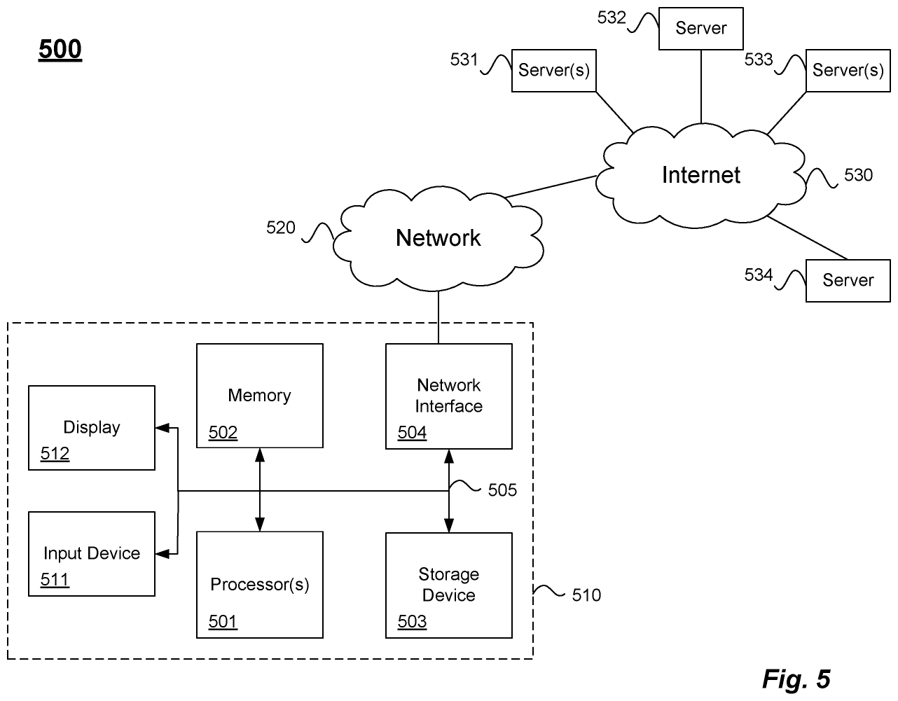

FIG. 5 illustrates hardware of a special purpose computing system 500 configured according to the above disclosure. The following hardware description is merely one example. It is to be understood that a variety of computers topologies may be used to implement the above-described techniques. An example computer system 510 is illustrated in FIG. 5. Computer system 510 includes a bus 505 or other communication mechanism for communicating information, and one or more processor(s) 501 coupled with bus 505 for processing information. Computer system 510 also includes memory 502 coupled to bus 505 for storing information and instructions to be executed by processor 501, including information and instructions for performing some of the techniques described above, for example. Memory 502 may also be used for storing programs executed by processor(s) 501. Possible implementations of memory 502 may be, but are not limited to, random access memory (RAM), read only memory (ROM), or both. A storage device 503 is also provided for storing information and instructions. Common forms of storage devices include, for example, a hard drive, a magnetic disk, an optical disk, a CD-ROM, a DVD, solid state disk, a flash or other non-volatile memory, a USB memory card, or any other electronic storage medium from which a computer can read. Storage device 503 may include source code, binary code, or software files for performing the techniques above, for example. Storage device 503 and memory 502 are both examples of non-transitory computer readable storage mediums (aka, storage media).

In some systems, computer system 510 may be coupled via bus 505 to a display 512 for displaying information to a computer user. An input device 511 such as a keyboard, touchscreen, and/or mouse is coupled to bus 505 for communicating information and command selections from the user to processor 501. The combination of these components allows the user to communicate with the system. In some systems, bus 505 represents multiple specialized buses for coupling various components of the computer together, for example.

Computer system 510 also includes a network interface 504 coupled with bus 505. Network interface 504 may provide two-way data communication between computer system 510 and a local network 520. Network 520 may represent one or multiple networking technologies, such as Ethernet, local wireless networks (e.g., WiFi), or cellular networks, for example. The network interface 504 may be a wireless or wired connection, for example. Computer system 510 can send and receive information through the network interface 504 across a wired or wireless local area network, an Intranet, or a cellular network to the Internet 530, for example. In some embodiments, a front end (e.g., a browser), for example, may access data and features on backend software systems that may reside on multiple different hardware servers on-prem 531 or across the Internet 530 on servers 532-534. One or more of servers 532-534 may also reside in a cloud computing environment, for example.

### Further Examples

Each of the following non-limiting features in the following examples may stand on its own or may be combined in various permutations or combinations with one or more of the other features in the examples below. In various embodiments, the present disclosure may be implemented as a system, method, or computer readable medium.

In one embodiment, the present disclosure includes a method of determining faults comprising: storing information specifying relationships between a plurality of software applications; receiving fault events from a plurality of software servers executing the plurality of software applications, the fault events comprising data specifying faults; storing the fault events; receiving a query, the query specifying information pertaining to a first fault in a first software application of the plurality of software applications; retrieving the information specifying relationships between the plurality of software applications; retrieving one or more first fault events from the stored fault events, based on the information pertaining to the first fault; retrieving, from second software applications of the plurality of software applications directly or indirectly interacting with the first software application, as determined from the first fault events and information specifying relationships between the plurality of software applications, information describing the first fault; and storing the information describing the first fault in a table.

In one embodiment, information specifying relationships between a plurality of software applications comprises one or more of: an identifier associated with the first software application, a server identifier associated with the first software application, an identifier associated with a second software application dependent on the first software application, a server identifier associated with the second software application, and one or more first fault search relevant fields; and a plurality of: an identifier associated with a parent software application, including at least the second software application, a server identifier associated with the parent software application, an identifier associated with a dependent software application dependent on the parent software application, a server identifier associated with the parent software application, and one or more second fault search relevant fields.

In one embodiment, the data specifying faults comprises: an identifier of the software application generating the fault event and one or more text fields in the fault events describing the fault events.

In one embodiment, the query specifying information pertaining to the first fault comprises an identifier associated with the first software application, an object identifier associated with an object in the first software application experiencing an error condition, and an identifier associated with a first server running the first software application.

In one embodiment, the information describing the first fault comprises an object identifier, an object type, a server identifier, a node identifier, a parent node identifier, a node level, and a fault log identifier.

In one embodiment, the plurality of software applications form a hierarchy.

In one embodiment, the first software application interfaces with one or more second software applications forming a second hierarchical layer, and the one or more second software applications interface with a plurality of third software applications across the hierarchy, and wherein the information specifying relationships between the plurality of software applications specifies a position of each software application in the hierarchy.

In one embodiment, the method further comprising iteratively connecting to the second and third software applications to retrieve fault event information.

In one embodiment, the method or computer system further comprising generating, based on the information describing the first fault in the table, a hierarchical model of interrelated fault events across the plurality of software applications and presenting the hierarchical model to a user.

In another embodiment, the present disclosure includes a computer system comprising: at least one processor; at least one non-transitory computer readable medium storing computer executable instructions that, when executed by the at least one processor, cause the computer system to perform a method of determining faults as described in the examples above.

In another embodiment, the present disclosure includes a non-transitory computer-readable medium storing computer-executable instructions that, when executed by at least one processor, perform a method of determining faults as described in the examples above.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method of determining faults comprising:
storing information specifying relationships between a plurality of software applications;
receiving fault events from a plurality of software servers executing the plurality of software applications, the fault events comprising data specifying faults;
storing the fault events;
receiving a query, the query specifying information pertaining to a first fault in a first software application of the plurality of software applications;
retrieving the information specifying relationships between the plurality of software applications;
retrieving one or more first fault events from the stored fault events, based on the information pertaining to the first fault;
retrieving, from second software applications of the plurality of software applications directly or indirectly interacting with the first software application, as determined from the first fault events and information specifying relationships between the plurality of software applications, information describing the first fault; and
storing the information describing the first fault in a table.

2. The method of claim 1, wherein information specifying relationships between a plurality of software applications comprises one or more of:
an identifier associated with the first software application, a server identifier associated with the first software application, an identifier associated with a second software application dependent on the first software application, a server identifier associated with the second software application, and one or more first fault search relevant fields; and
a plurality of:
an identifier associated with a parent software application, including at least the second software application, a server identifier associated with the parent software application, an identifier associated with a dependent software application dependent on the parent software application, a server identifier associated with the parent software application, and one or more second fault search relevant fields.

3. The method of claim 1, wherein the data specifying faults comprises: an identifier of the software application generating the fault event and one or more text fields in the fault events describing the fault events.

4. The method of claim 1, wherein the query specifying information pertaining to the first fault comprises an identifier associated with the first software application, an object identifier associated with an object in the first software application experiencing an error condition, and an identifier associated with a first server running the first software application.

5. The method of claim 1, wherein the information describing the first fault comprises an object identifier, an object type, a server identifier, a node identifier, a parent node identifier, a node level, and a fault log identifier.

6. The method of claim 1, wherein the plurality of software applications form a hierarchy.

7. The method of claim 6, wherein the first software application interfaces with one or more second software applications forming a second hierarchical layer, and the one or more second software applications interface with a plurality of third software applications across the hierarchy, and wherein the information specifying relationships between the plurality of software applications specifies a position of each software application in the hierarchy.

8. The method of claim 6, the method further comprising iteratively connecting to the second and third software applications to retrieve fault event information.

9. The method of claim 1, further comprising generating, based on the information describing the first fault in the table, a hierarchical model of interrelated fault events across the plurality of software applications and presenting the hierarchical model to a user.

10. A computer system comprising:
at least one processor;
at least one non-transitory computer readable medium storing computer executable instructions that, when executed by the at least one processor, cause the computer system to perform a method of determining faults comprising:
storing information specifying relationships between a plurality of software applications;
receiving fault events from a plurality of software servers executing the plurality of software applications, the fault events comprising data specifying faults;
storing the fault events;
receiving a query, the query specifying information pertaining to a first fault in a first software application of the plurality of software applications;
retrieving the information specifying relationships between the plurality of software applications;
retrieving one or more first fault events from the stored fault events, based on the information pertaining to the first fault;
retrieving, from second software applications of the plurality of software applications directly or indirectly interacting with the first software application, as determined from the first fault events and information specifying relationships between the plurality of software applications, information describing the first fault; and
storing the information describing the first fault in a table.

11. The computer system of claim 10, wherein the plurality of software applications form a hierarchy.

12. The computer system of claim 10, wherein information specifying relationships between a plurality of software applications comprises one or more of:
an identifier associated with the first software application, a server identifier associated with the first software application, an identifier associated with a second software application dependent on the first software application, a server identifier associated with the second software application, and one or more first fault search relevant fields; and
a plurality of:
an identifier associated with a parent software application, including at least the second software application, a server identifier associated with the parent software application, an identifier associated with a dependent software application dependent on the parent software application, a server identifier associated with the parent software application, and one or more second fault search relevant fields.

13. The computer system of claim 10, wherein the data specifying faults comprises: an identifier of the software application generating the fault event and one or more text fields in the fault events describing the fault events.

14. The computer system of claim 10, wherein the query specifying information pertaining to the first fault comprises an identifier associated with the first software application, an object identifier associated with an object in the first software application experiencing an error condition, and an identifier associated with a first server running the first software application.

15. The computer system of claim 10, wherein the information describing the first fault comprises an object identifier, an object type, a server identifier, a node identifier, a parent node identifier, a node level, and a fault log identifier.

16. A non-transitory computer-readable medium storing computer-executable instructions that, when executed by at least one processor, perform a method of determining faults, the method comprising:
storing information specifying relationships between a plurality of software applications;
receiving fault events from a plurality of software servers executing the plurality of software applications, the fault events comprising data specifying faults;
storing the fault events;
receiving a query, the query specifying information pertaining to a first fault in a first software application of the plurality of software applications;
retrieving the information specifying relationships between the plurality of software applications;
retrieving one or more first fault events from the stored fault events, based on the information pertaining to the first fault;
retrieving, from second software applications of the plurality of software applications directly or indirectly interacting with the first software application, as determined from the first fault events and information specifying relationships between the plurality of software applications, information describing the first fault; and
storing the information describing the first fault in a table.

17. The non-transitory computer-readable medium of claim 16, wherein the plurality of software applications form a hierarchy.

18. The non-transitory computer-readable medium of claim 16, wherein information specifying relationships between a plurality of software applications comprises one or more of:
an identifier associated with the first software application, a server identifier associated with the first software application, an identifier associated with a second software application dependent on the first software application, a server identifier associated with the second software application, and one or more first fault search relevant fields; and
a plurality of:
an identifier associated with a parent software application, including at least the second software application, a server identifier associated with the parent software application, an identifier associated with a dependent software application dependent on the parent software application, a server identifier associated with the parent software application, and one or more second fault search relevant fields.

19. The non-transitory computer-readable medium of claim 16, wherein the data specifying faults comprises: an identifier of the software application generating the fault event and one or more text fields in the fault events describing the fault events.

20. The non-transitory computer-readable medium of claim 16, wherein the query specifying information pertaining to the first fault comprises an identifier associated with the first software application, an object identifier associated with an object in the first software application experiencing an error condition, and an identifier associated with a first server running the first software application.
